(19) United States
(12) Patent Application Publication
(10) Pub. No.: US 2010/0005519 A1
(43) Pub. Date: Jan. 7, 2010

(54) SYSTEM AND METHOD FOR AUTHENTICATING ONE-TIME VIRTUAL SECRET INFORMATION

(76) Inventor: Byung-ryul Lim, Seoul (KR)

Correspondence Address: NYDEGGER & ASSOCIATES, 348 OLIVE STREET, SAN DIEGO, CA, 92103, US

(21) Appl. No.: 12/174,487

(22) Filed: Jul. 16, 2008

(30) Foreign Application Priority Data
Nov. 27, 2007 (KR) 10-2007-0121164

(51) Int. Cl. H04L 9/32

(52) U.S. Cl. 726/6

(57) ABSTRACT

A system for authenticating one-time virtual secret information includes a display device and an input device separated from each other, the display device having a central processing unit (CPU) and a memory and the input device having a CPU and a memory. An authentication server generates matching information, for display on the display device via a communication network. A user views this matching information and inputs the one-time virtual secret information to the input device. The input device then transmits the input one-time virtual secret information to the authentication server via a communication network, and the authentication server interprets the input one-time virtual secret information.

### CROSS-REFERENCE TO RELATED PATENT APPLICATION

This application claims the benefit of Korean Patent Application No. 10-2007-0121164, filed on Nov. 27, 2007, in the Korean Intellectual Property Office, the disclosure of which is incorporated herein in its entirety by reference.

### BACKGROUND OF THE INVENTION

1. Field of the Invention

The present invention relates to a system and method for authenticating one-time virtual secret information that are capable of safely transmitting user secret information to an authentication server when user authentication is critically requested for Internet-based financial transaction, personal health information, and research projects of companies. More particularly, the present invention relates to a system and method for authenticating one-time virtual secret information that are capable of incapacitating hacking by separating an input device for inputting the one-time virtual secret information from a display device for displaying matching information required for input of the one-time virtual secret information to prevent leakage of user's true secret information.

2. Description of the Related Art

There are conventional techniques of transferring secret information:

(1) Encryption and Transfer Method

A secret information input system encrypts secret information and transfers the encrypted secret information to an authentication server. This method provides security for a communication network. There is a likelihood of hacking in an input stage (e.g., a personal computer).

(2) Security Keyboard Input Method

In order to prevent hacking, user-input secret information is encrypted with a high-security keyboard of a secret information input system rather than a conventional keyboard and transmitted to an authentication server. However, this method requires an additional cost for hardware and increases a burden on a user.

(3) Two-way Secret Information Input Method

A user inputs secret information via two channels and an authentication server combines input information to complete the secret information. This method may assure high security because of difficulty of simultaneous hacking of the two channels. However, part of user-input secret information may leak in respective systems using the two channels. As a result, the secret information is likely to leak through continuous information collection.

(4) Challenge-Response Method

A secret information input system receives an encryption key for encrypting secret information from an authentication server, encrypts the secret information with the received encryption key, and transmits the encrypted secret information to the authentication server. However, in this method, encryption in the secret information input system may cause the secret information to be hacked and leaked by any secret information input system using the same encryption scheme.

An “Electronic signature System and Method Using Mobile Phone” is disclosed in Korean Patent Application No. 2006-94740, filed Sep. 28, 2006.

The electronic signature system using a mobile phone includes a subscriber client including a subscriber mobile phone for generating an electronic signature with a certificate and an electronic signature key that are stored in advance, and a subscriber PC for receiving the electronic signature from the subscriber mobile phone and submitting the same to a foreign authority; a relay authority for connecting between the subscriber PC on a wired network and the subscriber mobile phone on a wireless network and relaying electronic signature generation; and a mobile communication company for performing various procedures requested by a relay authority on the subscriber mobile phone.

However, in the electronic signature system and method using a mobile phone, when secret information to be transferred by a user is forged on a memory and the forged secret information is crudely transferred with electronic signature, the authentication server may perform tasks on such wrong information. It is difficult to safely transfer a certificate to the mobile phone, and a hacker may obtain any random number values, for example, through user screen capture or memory hacking. Since an electronic signature value for the user-input secret information is generated by the mobile phone, the input secret information may be easily leaked by keyboard or memory hacking even though it may be prevented from being forged and falsified.

### SUMMARY OF THE INVENTION

The present invention provides a system and method for authenticating one-time virtual secret information that are capable of incapacitating hacking by separating an input device for inputting the one-time virtual secret information from a display device for displaying matching information required for input of the one-time virtual secret information and by allowing a user to input the one-time virtual secret information to the input device using matching information displayed on the display device separated from the input device, so that a hacker who attempts to hack the input device does not obtain user's true secret information even though he or she may obtain one-time virtual secret information.

According to an aspect of the present invention, there is provided a system for authenticating one-time virtual secret information, the system comprising: a display device and an input device separated from each other, the display device having a central processing unit (CPU) and a memory and the input device having a CPU and a memory, allowing the display device and the input device to independently process information, wherein: an authentication server generates matching information, the authentication server including a database, when the authentication server provides the generated matching information to the display device via a communication network, the display device displays the matching information so that a user views the matching information and inputs the one-time virtual secret information, when the user inputs the one-time virtual secret information to the input device, the input device transmits the input one-time virtual secret information to the authentication server via a communication network, and the authentication server interprets the input one-time virtual secret information to determine whether to authenticate the input information.

The matching information may include a secret information index table including ten sequential numeric digits, and a secret information matching value table including ten numeric digits randomly matching with the numeric digits of the secret information index table, respectively.

As another alternative, the secret information index table of the matching information may include any one of a combination of 26 alphabetic letters, alphabetic letters and numeric digits, a combination of the numeric digits and special characters, a combination of the alphabetic letters and the special characters, and a combination of the numeric digits, the alphabetic letters, and the special characters, and the combination of 26 alphabetic letters, alphabetic letters and numeric digits, the combination of the numeric digits and special characters, the combination of the alphabetic letters and the special characters, or the combination of the numeric digits, the alphabetic letters, and the special characters may be randomly written to the secret information matching value table in a one-to-one correspondence relationship.

As yet another alternative, the matching information may comprise any one of information provided from a secret process unit (SPU) to a display unit disclosed in Korean Patent No. 0536072, information provided from an SPU to a display unit disclosed in Korean Patent No. 0623684, a matching table disclosed in Korean Patent No. 0734592, a security card disclosed in Korean Patent Application No. 2005-0053799, an OTP card disclosed in Korean Patent Application No. 2005-0068767, and a VIS security card disclosed in Korean Patent Application No. 2006-0027755.

Each of the communication network connecting between the authentication server and the display device and the communication network connecting between the authentication server and the input device may be any one of the Internet, a mobile communication network, and a public switched telephone network, and the communication network connecting between the authentication server and the display device and the communication network connecting between the authentication server and the input device differ from each other.

The display device may be either a mobile phone or a display device, the display device including a CPU, a memory having an authenticated key for a user stored therein, a display unit for displaying matching information, a personal computer (PC) interface for connection to a PC, and a controller for controlling the PC interface and the display unit.

The PC interface may be any one of a universal serial bus (USB), a serial/parallel port, Bluetooth, a 1394 port, and Radio-frequency identification (RFID).

According to another aspect of the present invention, there is provided a method for authenticating one-time virtual secret information, the method comprising: connecting a mobile phone to an authentication server via a mobile communication company communication network, and connecting a PC to the authentication server via the Internet; generating, by the authentication server, first matching information and outputting the first matching information to the user mobile phone via the mobile communication company communication network; inputting, by a user, one-time virtual secret information matching with an index value corresponding to the first secret information in the matching information displayed on the mobile phone, to the PC; when the one-time virtual secret information is input to the PC, generating, by the authentication server, second matching information and outputting the second matching information to the mobile phone; repeatedly generating and outputting, by the authentication server, matching information to the mobile phone until “n” one-time virtual secret information are input to the PC; when the “n” one-time virtual secret information are all input to the PC, transmitting, by the PC, the “n” one-time virtual secret information to the authentication server; and interpreting, by the authentication server, the one-time input virtual secret information, based on its generated matching information.

According to yet another aspect of the present invention, there is provided a method for authenticating one-time virtual secret information, the method comprising: connecting a mobile phone to an authentication server via a mobile communication company communication network, and connecting a PC to the authentication server via the Internet; generating, by the authentication server, first matching information and outputting the first matching information to the PC via the Internet; inputting, by a user, one-time virtual secret information matching with an index value corresponding to the first secret information in the matching information displayed on the PC, to the mobile phone; when the one-time virtual secret information is input to the mobile phone, generating, by the authentication server, second matching information and outputting the second matching information to the PC; repeatedly generating and outputting, by the authentication server, matching information to the PC until “n” one-time virtual secret information are input to the mobile phone; when the “n” one-time virtual secret information are all input to the mobile phone, transmitting, by the mobile phone, the “n” one-time virtual secret information to the authentication server; and interpreting, by the authentication server, the input one-time virtual secret information, based on its generated matching information.

In this method for authenticating one-time virtual secret information, the authentication server may generate “n” matching information, tying the “n” matching information into one information package, and transmitting the information package to the mobile phone, and when the authentication server sends a signal to the mobile phone to request the mobile phone to output next matching information, the mobile phone may sequentially display the matching information in the information package in response to the request.

According to yet another aspect of the present invention, there is provided a method for authenticating one-time virtual secret information, the method comprising: connecting a PC to an authentication server via the Internet; generating, by the authentication server, first matching information and outputting the first matching information to a display device; inputting, by a user, one-time virtual secret information matching with an index value corresponding to the first secret information in the matching information displayed on the display device, to the PC; when the one-time virtual secret information is input to the PC, generating, by the authentication server, second matching information and outputting the second matching information to the display device; repeatedly generating and outputting, by the authentication server, matching information to the display device until “n” one-time virtual secret information are input to the PC; when the “n” one-time virtual secret information are all input to the PC, transmitting, by the PC, the “n” one-time virtual secret information to the authentication server; and interpreting, by the authentication server, the “n” input one-time virtual secret information.

According to yet another aspect of the present invention, there is provided a method for authenticating one-time secret information, the method comprising: connecting a PC having a display device to an authentication server via the Internet; generating, by the authentication server, “n” matching information, encrypting the “n” generated matching information, transmitting the encrypted information to a display device via the PC; decrypting, by the display device, the encrypted information and displaying first matching information; inputting, by a user, one-time virtual secret information matching with an index value corresponding to the first secret information in the matching information displayed on the display device, to the PC; when the one-time virtual secret information is input to the PC, generating, by the display device, second matching information and outputting the second matching information; repeatedly generating and outputting, by the display device, matching information until “n” one-time virtual secret information are input to the PC; when the “n” one-time virtual secret information are all input to the PC, transmitting, by the PC, the “n” one-time virtual secret information to the display device and requesting to encrypt the “n” one-time virtual secret information; encrypting, by the display device, the “n” one-time virtual secret information with an encryption key stored in a memory, and transmitting the encrypted secret information to the authentication server via the PC; and decrypting, by the authentication server, the encrypted information, and interpreting the “n” one-time virtual secret information.

In the method for authenticating one-time secret information, when the “n” one-time virtual secret information are all input to the PC, the PC may request to encrypt the matching information and the display device may encrypt the matching information with the encryption key value stored in the memory, so that the “n” one-time virtual secret information and the encrypted matching information are transmitted to the authentication server.

In the method for authenticating one-time secret information, when the “n” one-time virtual secret information are all input to the PC, the PC may transmit the “n” one-time virtual secret information to the display device and requests to encrypts the one-time virtual secret information, and the display device may interpret actual secret information from the one-time virtual secret information using the matching information, encrypt the interpreted actual secret information with the encryption key value stored in the memory, and transmit the encrypted actual secret information to the authentication server via the PC.

The method for authenticating one-time secret information further may include: when the “n” one-time virtual secret information are input to the authentication server, transmitting, by the authentication server, the “n” one-time virtual secret information to the display device to confirm whether the user has correctly inputted the “n” one-time virtual secret information.

In the method for authenticating one-time secret information, the generating and outputting of matching information and the inputting of one-time virtual secret information may be performed by any one of methods disclosed in Korean Patent Nos. 0536072, 0623684, 0734592 and Korean Patent Application Nos. 2005-0053799, 2005-0068767, and 2006-0027755.

According to yet another aspect of the present invention, there is provided a method for authenticating one-time virtual secret information, the method comprising: generating, by a display device, first matching information in response to a request from a PC and displaying the first matching information; inputting, by a user, one-time virtual secret information matching with an index value corresponding to its first secret information in the matching information displayed on the display device, to the PC; when the one-time virtual secret information is input to the PC, generating and outputting, by the display device, second matching information; repeatedly generating and outputting, by an authentication server, matching information to the display device until “n” one-time virtual secret information are input to the PC in that way; when the “n” one-time virtual secret information are all input to the PC, transmitting, by the PC, the “n” one-time virtual secret information to the display device; and interpreting, by the display device, the “n” input one-time virtual secret information, based on the matching information, and determining whether to approve use of the display device.

As described above, in the system and method for authenticating one-time virtual secret information according to the present invention, the input of the one-time virtual secret information is made by the PC and the matching information is output to a mobile phone or a standalone display device. Accordingly, a hacker who attempts to hack the PC via the Internet may obtain one-time virtual secret information, but cannot obtain user's true secret information, thereby incapacitating hacking.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram illustrating a system for authenticating one-time virtual secret information according to the present invention;

FIG. 2 illustrates a table of matching information;

FIG. 3 is a block diagram illustrating a display device;

FIG. 4 is a block diagram illustrating an example of a system for implementing a method for authenticating one-time virtual secret information according to the present invention;

FIG. 5 is a flowchart illustrating a method for authenticating one-time virtual secret information according to the present invention;

FIGS. 6 to 9 are schematic diagrams illustrating orders to display matching information and input “n” one-time virtual secret information;

FIG. 10 is a block diagram illustrating another example of a system for implementing a method for authenticating one-time virtual secret information according to the present invention;

FIG. 11 is a flowchart illustrating an example of a method for authenticating one-time virtual secret information according to the present invention;

FIG. 12 is a flowchart illustrating another example of a method for authenticating one-time virtual secret information according to the present invention;

FIG. 13 is a flowchart illustrating yet another example of a method for authenticating one-time virtual secret information according to the present invention; and

FIG. 14 is a flowchart illustrating yet another example of a method for authenticating one-time virtual secret information according to the present invention.

### DESCRIPTION OF THE PREFERRED EMBODIMENTS

The present invention will now be described more fully hereinafter with reference to the accompanying drawings

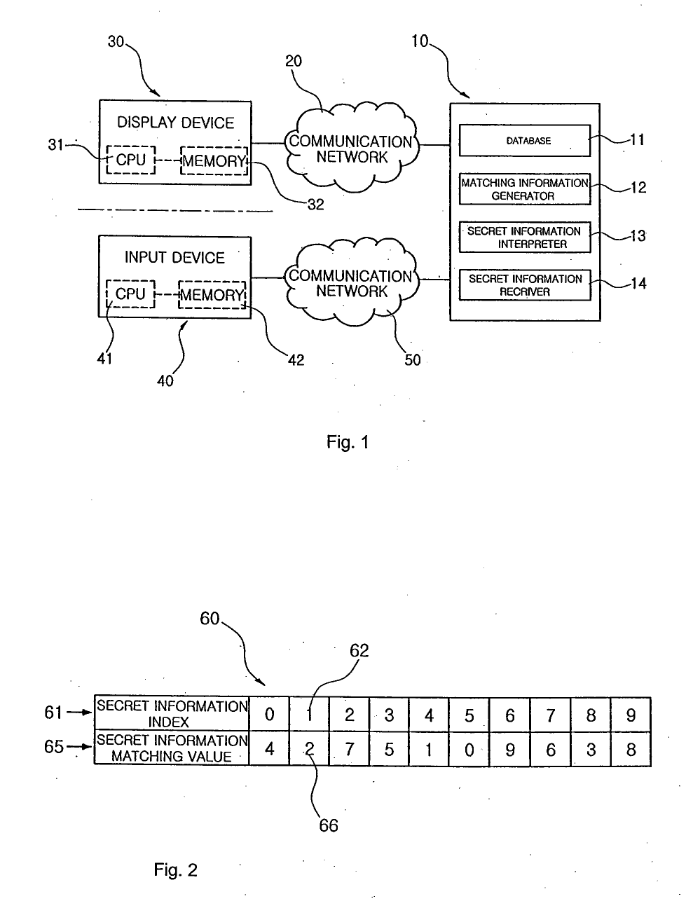

Referring to FIG. 1, a system for authenticating one-time virtual secret information according to a first embodiment of the present invention includes a display device 30 and an input device 40 separated from each other. The display device 30 has a CPU 31 and a memory 32 and the input device 40 has a CPU 41 and a memory 42, allowing the display device 30 and the input device 40 to independently process information. When an authentication server 10 including a database 11 generates matching information and provides the same to the display device 30 via a communication network 20. The display device 30 displays the matching information so that a user views the matching information and inputs one-time virtual secret information. When the user inputs the one-time virtual secret information to the input device 40, the input device 40 transmits the input one-time virtual secret information to the authentication server 10 via a communication network 50. The authentication server 10 interprets the input one-time virtual secret information.

In the system for authenticating one-time virtual secret information, the authentication server 10 stores the interpreted actual secret information or sends the same to a cooperation system (not shown) to be used according to the purpose of use. When the interpreted actual secret information is a password, the authentication server 10 determines whether the password matches with user secret information stored in the database to determine whether to authenticate the information.

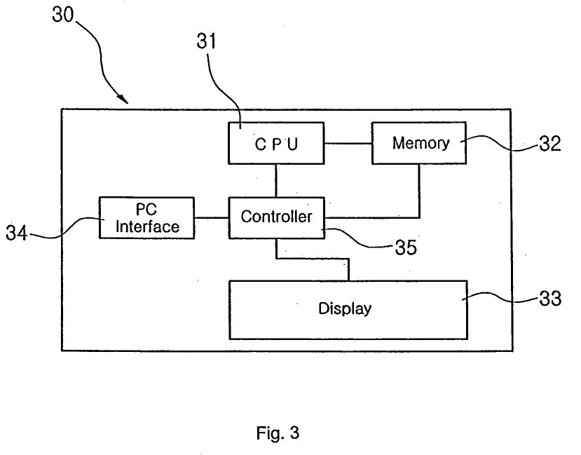

Referring to FIG. 2, the matching information 60 includes a secret information index table 61 including ten sequential numeric digits, and a secret information matching value table 65 including ten numeric digits randomly matching with the numeric digits of the secret information index table 61, respectively. Here, the numeric digits of the secret information index table 61 indicate secret information values to be input by the user, and the numeric digits of the secret information matching value table indicate one-time virtual secret information values randomly matching with the numeric digits of the secret information index table 61 in a one-to-one correspondence relationship, respectively.

As another alternative, the secret information index table 61 of the matching information 60 may include any one of a combination of 26 alphabetic letters, alphabetic letters and numeric digits, a combination of numeric digits and special characters, a combination of alphabetic letters and special characters, or a combination of numeric digits, alphabetic letters, and special characters. The combination of 26 alphabetic letters, alphabetic letters and numeric digits, the combination of the numeric digits and special characters, the combination of the alphabetic letters and the special characters, or the combination of the numeric digits, the alphabetic letters, and the special characters may be randomly written to the secret information matching value table 65 in a one-to-one correspondence relationship.

As yet another alternative, the matching information may be information provided from a secret process unit (SPU) to a display unit, disclosed in our Korean Patent No. 0536072 (issued on Dec. 6, 2005 and entitled “Apparatus For Inputting Secret Information And Method For Interpreting secret Information”), information provided from an SPU to a display unit, disclosed in our Korean Patent No. 0623684 (issued on Sep.6, 2006, and entitled “Apparatus And Method For Inputting And Interpreting Secret Information”), a matching table disclosed in our Korean Patent No. 0734592 (issued on Jun. 26, 2007 and entitled “Method For Authenticating Password”), a security card disclosed in Korean Patent Application No. 2005-0053799 (filed Jun. 22, 2005 and entitled “Method For Inputting And Interpreting Secret Information”), an OTP card disclosed in Korean Patent Application No. 2005-0068767 (filed Jul. 28, 2005 and entitled “Method For Generating And Interpreting One-time Password”), or a VIS security card disclosed in Korean Patent Application No. 2006-0027755 (filed Mar. 28, 2006 and entitled “Secure Method For Generating One Time Password And Interpreting One Time Password”).

The communication network 20 or 50 is any one of the Internet, a mobile communication network, and a public switched telephone network. The communication network 20 connecting between the authentication server 10 and the display device 30 and the communication network 50 connecting between the authentication server 10 and the input device 40 differ from each other.

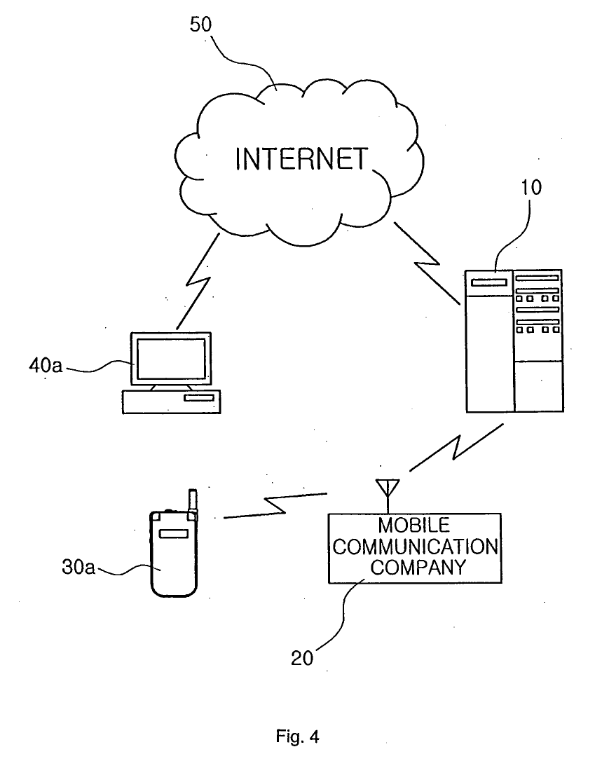

The display device 30 may be a mobile phone, or a display device comprising a CPU 31, a memory 32 having an authenticated key for a user stored therein, a display unit 33 for displaying matching information, a PC interface 34 for connection to a PC, and a controller 35 for controlling the PC interface 34 and display unit 33, as shown in FIG. 3.

The PC interface 34 is any one of a universal serial bus (USB), a serial/parallel port, Bluetooth, a 1394 port, and an RFID.

The method for authenticating one-time virtual secret information in which a mobile phone or a mobile terminal is used as the display device 30 in the system for authenticating one-time virtual secret information according to the present invention will be described in detail.

The input device communicates a message with the authentication server via a general PC or the Internet.

Operation of the secret information input unit will be described in detail in connection with the method for authenticating one-time virtual secret information according to the present invention that will be described below.

Embodiments of the method for authenticating one-time virtual secret information in the system for authenticating one-time virtual secret information according to a first embodiment of the present invention configured as above will be described with reference to the accompanying drawings.

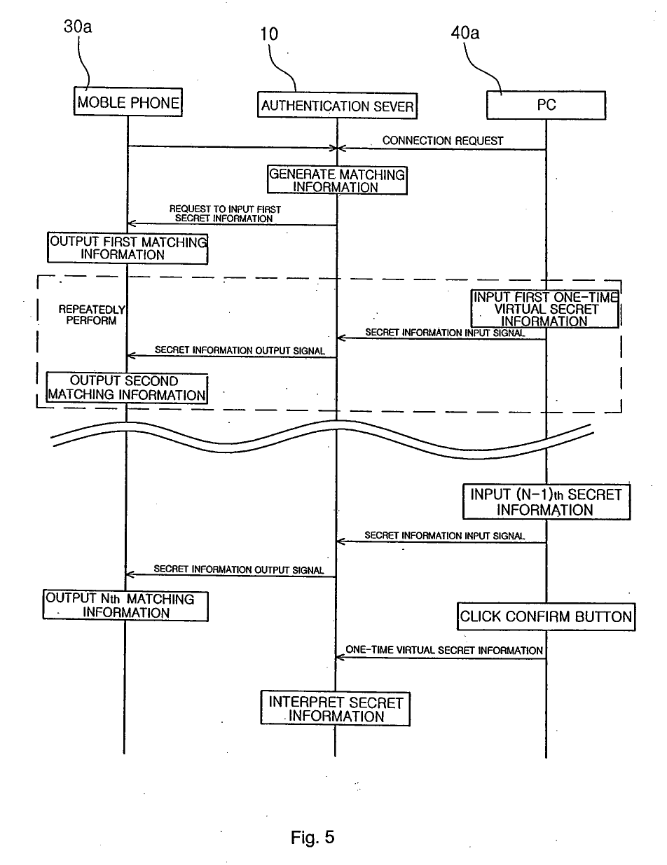

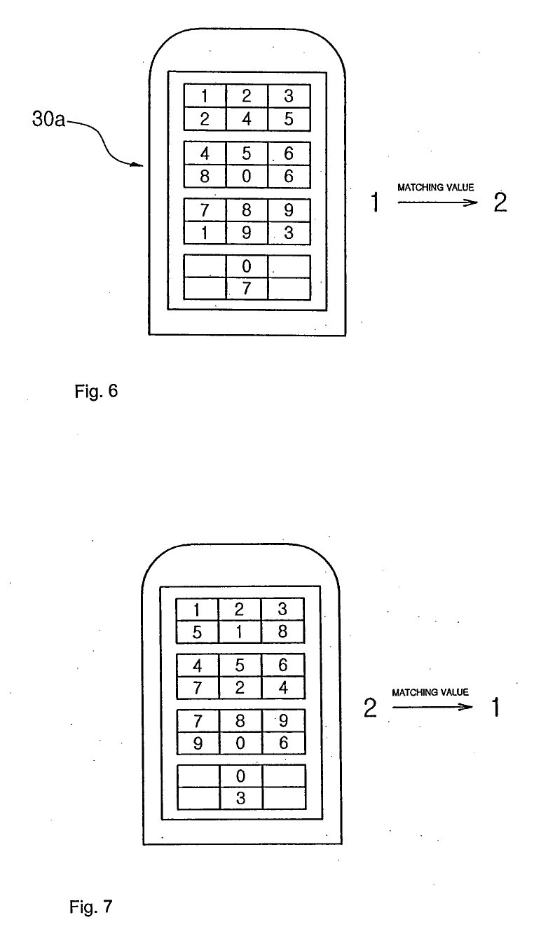

Referring to FIGS. 4 and 5, in the method for authenticating one-time virtual secret information according to the first embodiment of the present invention, the input device 40 is an Internet-based PC 40a and the display device 30 is a mobile phone 30a. In the description, the input device is generally referred to as a PC and the display device is generally referred to as mobile phone.

The mobile phone 30a is connected to the authentication server 10 via a mobile communication company communication network 20, and the PC 40a is connected to the authentication server 10 via the Internet 50. In this case, the mobile phone 30a and PC 40a may be connected in an arbitrary order.

The authentication server 10 then generates first matching information and outputs the same to the user mobile phone 30a via the mobile communication company communication network 20.

The user then inputs one-time virtual secret information matching with an index value corresponding to the first secret information in the matching information displayed on the mobile phone 30a, to the PC 40a.

When the one-time virtual secret information is input to the PC 40a, the authentication server 10 generates second matching information and outputs the same to the mobile phone 30a.

In this method, the authentication server 10 repeatedly generates and outputs the matching information to the mobile phone 30a until “n” one-time virtual secret information are input to the PC 40a.

When the “n” one-time virtual secret information are all input to the PC 40a, the PC 40a transmits the “n” one-time virtual secret information to the authentication server 10.

The authentication server 10 then interprets the input one-time virtual secret information, based on its generated matching information.

In the above method for authenticating one-time virtual secret information according to the first embodiment of the present invention, the authentication server 10 may generate “n” matching information, tie the “n” matching information into one information package, and transmit the information package to the display device 30. The display device 30 may sequentially display the matching information in the information package.

In the above method for authenticating one-time virtual secret information according to the first embodiment of the present invention, the actual secret information interpreted by the authentication server 10 may be stored or transmitted to a cooperation system (not shown) to be used according to the purpose of use. When the actual secret information interpreted by the authentication server 10 is a password, a determination is made as to whether the password matches with the user secret information stored in the database to determine whether to authenticate the information.

The method for authenticating one-time virtual secret information according to the first embodiment of the present invention may further include: when the “n” one-time virtual secret information are input to the authentication server 10, transmitting, by the authentication server 10, the “n” one-time virtual secret information to the mobile phone 30a to confirm whether the user has correctly inputted the “n” one-time virtual secret information.

A process by which the authentication server generates the first matching information and outputs the same to the user mobile phone via the mobile communication company communication network, and the user inputs one-time virtual secret information matching with an index value corresponding to its first secret information in the matching information displayed on the mobile phone, to a secret information input box of the PC in the method for authenticating one-time virtual secret information according to the first embodiment of the present invention will be described by way of example.

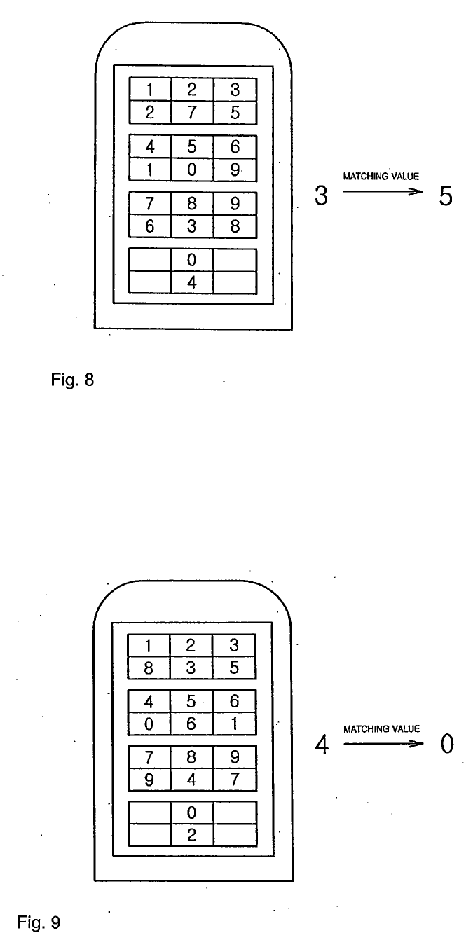

For example, when user's true original secret information is ‘1234’ and the authentication server outputs the first matching information to the mobile phone as shown in FIG. 6, the user views the mobile phone 30a and inputs one-time virtual secret information ‘2’ matching with original secret information ‘1’ to the PC.

Thereafter, when the authentication server outputs second matching information to the mobile phone as shown in FIG. 7, the user views the mobile phone and inputs one-time virtual secret information ‘1’ matching with original secret information ‘2’ to the secret information input box of the PC.

Thereafter, when the authentication server outputs third matching information to the mobile phone as shown in FIG. 8, the user views the mobile phone and inputs one-time virtual secret information ‘5’ matching with original secret information ‘3’ to the secret information input box of the PC.

Thereafter, when the authentication server outputs fourth matching information to the mobile phone as shown in FIG. 9, the user views the mobile phone and inputs one-time virtual secret information ‘0’ matching with original secret information ‘4’ to the secret information input box of the PC.

When the PC 40a transmits the one-time virtual secret information ‘2150’ to the authentication server 10, the authentication server 10 reversely interprets the original secret information ‘1234’ from the one-time virtual secret information ‘2150’, based on the generated matching information.

The authentication server 10 may then store or transmit the interpreted actual secret information to a cooperation system (not shown) so that the interpreted actual secret information is used for a social security number, credit card number according to the purpose of use. In particular, when the interpreted actual secret information is a password, the authentication server 10 determines whether the password matches with the user secret information stored in the database to determine whether to authenticate the information.

Alternatively, the one-time virtual secret information may be input and output by techniques disclosed in our Korean Patent No. 0536072 entitled “Apparatus For Inputting Secret Information And Method For Interpreting secret Information”, our Korean Patent No. 0623684 entitled “Apparatus And Method For Inputting And Interpreting Secret Information”, our Korean Patent No. 0734592 entitled “Method For Authenticating Password, Korean Patent Application No. 2005-0053799 entitled “Method For Inputting And Interpreting Secret Information”, Korean Patent Application No. 2005-0068767 entitled “Method For Generating And Interpreting One-time Password”, and Korean Patent Application No. 2006-0027755 entitled “Secure Method For Generating One Time Password And Interpreting One Time Password”.

As described above, in the method for authenticating one-time virtual secret information according to the first embodiment of the present invention, the input of the one-time virtual secret information is made by the PC and the matching information is output to the mobile phone. Accordingly, a hacker who attempts to hack the PC via the Internet may obtain one-time virtual secret information, but cannot obtain user's true secret information, thereby incapacitating hacking.

A method for authenticating one-time virtual secret information according to a second embodiment of the present invention is the same as the method for authenticating one-time virtual secret information according to the first embodiment of the present invention, except that when the authentication server transmits matching information to the PC via the Internet, the user views the matching information displayed on the PC and inputs one-time virtual secret information to the mobile phone.

In the method for authenticating one-time virtual secret information according to the first and second embodiments of the present invention, the authentication server 10 may generate “n” matching information, tie the “n” matching information into one information package, and transmit the information package to the mobile phone. When the authentication server sends a signal to the mobile phone to request the mobile phone to output next matching information, the mobile phone may sequentially display the matching information in the information package in response to the request.

As described above, in the method for authenticating one-time virtual secret information according to the second embodiment of the present invention, the reception of the matching information is made by the PC and the transmission of the one-time virtual secret information to the authentication server is made by the mobile phone. Accordingly, a hacker who attempts to hack the PC via the Internet may obtain one-time virtual secret information, but cannot obtain user's true secret information, thereby incapacitating hacking.

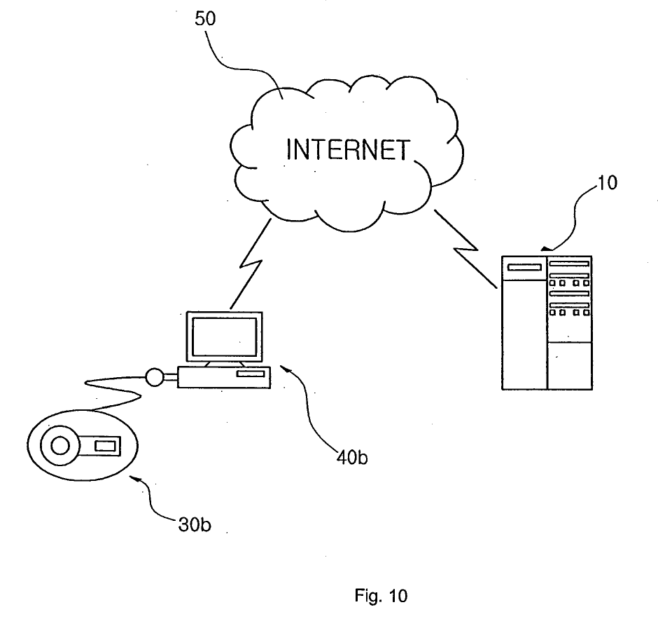

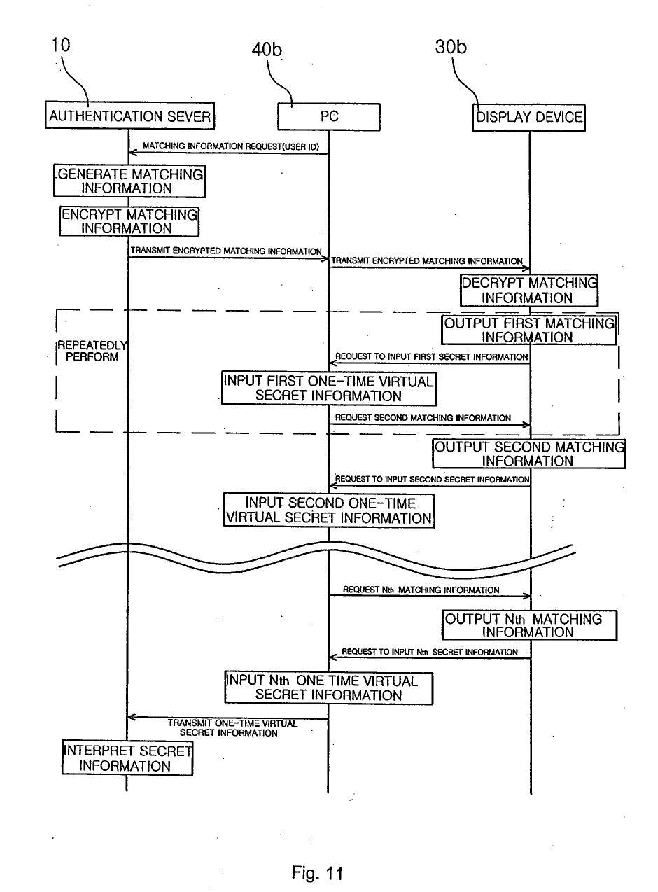

Referring to FIGS. 10 and 11, in a method for authenticating one-time virtual secret information according to a third embodiment of the present invention, the input device 40 shown in FIG. 1 is an Internet-based PC 40b, and the display device is a portable display device 30b that can be mounted to the PC and has the configuration illustrated in FIG. 3.

The PC 40b is connected to the authentication server 10 via the Internet 50. In this case, the display device 30b is automatically connected to the authentication server 10 via the PC 40b.

The authentication server 10 then generates first matching information, and outputs the first matching information to the display device 30b. In this case, the matching information output by the authentication server 10 is directly transmitted to the display device instead of being stored in a CPU or a memory of the PC.

A user then inputs one-time virtual secret information matching with an index value corresponding to its first secret information in the matching information displayed on the display device 30b, to the PC 40b.

When the one-time virtual secret information is input to the PC 40b, the authentication server 10 generates second matching information and outputs the same to the display device 30b.

In this method, the authentication server repeatedly generates and outputs the matching information to the display device until the “n” one-time virtual secret information are input to the PC.

When the “n” one-time virtual secret information are all input to the PC, the PC 40b transmits the “n” one-time virtual secret information to the authentication server 10.

The authentication server 10 then interprets the “n” input one-time virtual secret information.

In the method for authenticating one-time virtual secret information, the authentication server 10 may generate “n” matching information, tie the “n” matching information into one information package, and transmit the information package to the display device 30b. When the authentication server transmits a signal to request the display device 30b to output matching information, the display device can sequentially display the matching information in the information package in response to the request.

In the method for authenticating one-time virtual secret information according to the third embodiment of the present invention, the actual secret information interpreted by the authentication server 10 may be stored or transmitted to a cooperation system (not shown) to be used according to the purpose of use. When the actual secret information interpreted by the authentication server 10 is a password, a determination is made as to whether the password matches with the user secret information stored in the database to determine whether to authenticate the information.

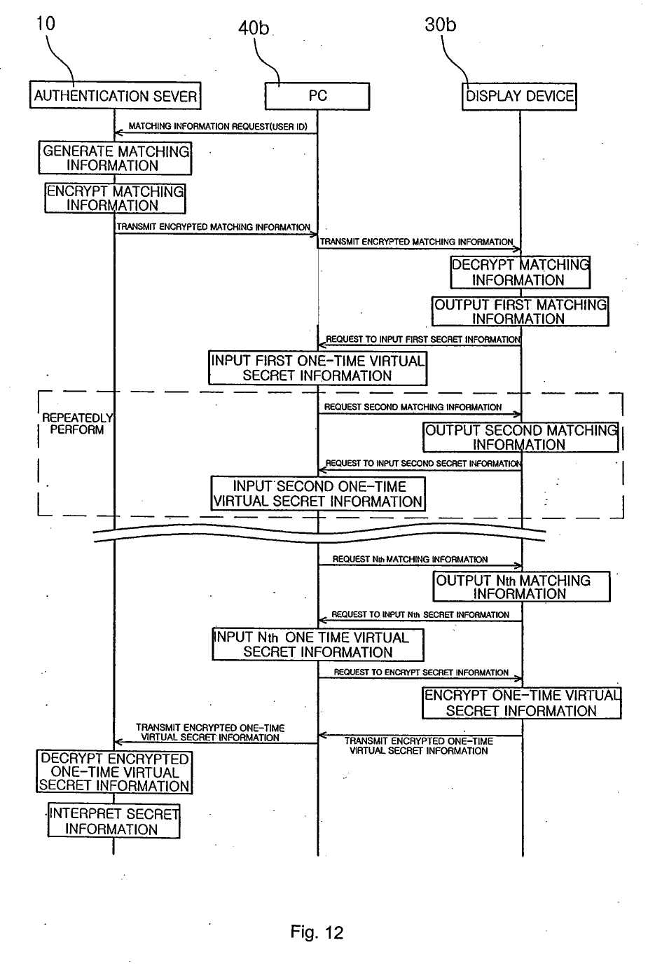

Referring to FIG. 12, in a method for authenticating one-time virtual secret information according to a fourth embodiment of the present invention, the PC 40b is connected to the authentication server 10 via the Internet 50. In this case, the display device 30b is automatically connected to the authentication server via the PC.

The authentication server 10 generates “n” matching information, encrypts the “n” generated matching information, and transmits the encrypted information to the display device 30b via the PC

The display device 30b decrypts the encrypted information, and displays the first matching information.

A user then inputs one-time virtual secret information matching with an index value corresponding to its first secret information in the matching information displayed on the display device to the PC.

When the one-time virtual secret information is input to the PC, the display device generates and outputs second matching information.

In this method, the authentication server repeatedly generates and outputs matching information to the display device until the “n” one-time virtual secret information are input to the PC.

When the “n” one-time virtual secret information are all input to the PC, the PC transmits the “n” one-time virtual secret information to the display device, and requests the display device to encrypt the “n” one-time virtual secret information.

The display device 30b then encrypts the “n” one-time virtual secret information with an encryption key stored in a memory, and transmits the encrypted secret information to the authentication server 10 via the PC 40b.

The authentication server 10 then decrypts the encrypted information and interprets the “n” one-time virtual secret information.

In the method for authenticating one-time virtual secret information according to the fourth embodiment of the present invention, the actual secret information interpreted by the authentication server 10 is stored or transmitted to a cooperation system (not shown) to be used for a social security number, a credit card number, or the like according to the purpose of use. In particular, when the actual secret information interpreted by the authentication server 10 is a password, a determination is made as to whether the password matches with the user secret information stored in the database to determine whether to authenticate the information.

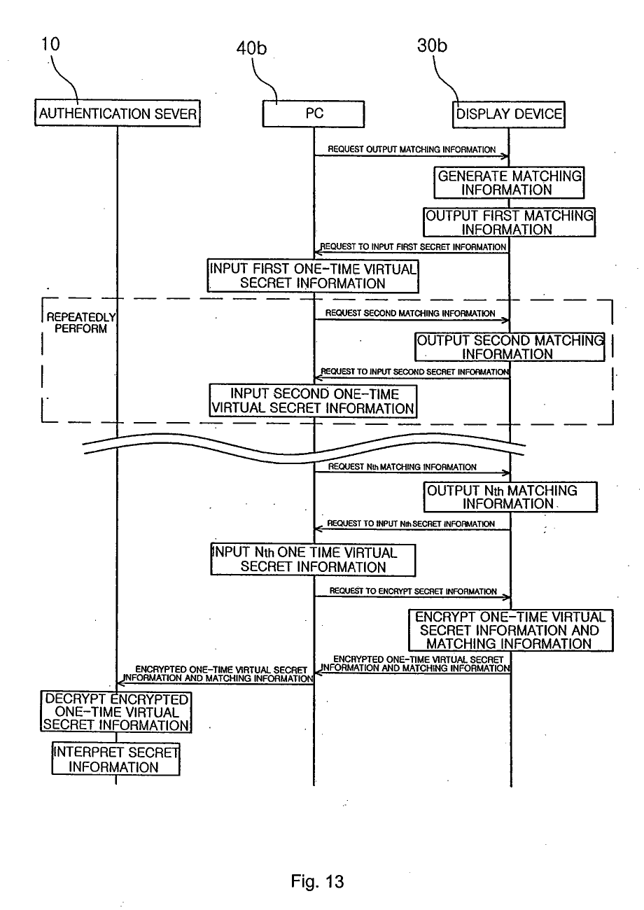

Referring to FIG. 13, in a method for authenticating one-time virtual secret information according to a fifth embodiment of the present invention, the display device 30b generates first matching information and displays the first matching information in response to a request from the PC 40b.

A user then inputs one-time virtual secret information matching with an index value corresponding to its first secret information in the matching information displayed on the display device to the PC.

When the one-time virtual secret information is input to the PC, the display device generates and outputs second matching information.

In this method, the authentication server repeatedly generates and outputs matching information to the display device until the “n” one-time virtual secret information are input to the PC.

When the “n” one-time virtual secret information are all input to the PC 40b, the PC transmits the “n” one-time virtual secret information to the display device and requests the display device to encrypt the “n” one-time virtual secret information and the matching information.

The display device 30b then encrypts the “n” one-time virtual secret information with an encryption key value stored in a memory, and transmits the encrypted secret information to the authentication server 10 via the PC 40b.

The authentication server 10 then decrypts the encrypted one-time virtual secret information and matching information, and interprets the one-time virtual secret information and the matching information.

In the method for authenticating one-time virtual secret information according to the fifth embodiment of the present invention, the actual secret information interpreted by the authentication server 10 may be stored or transmitted to a cooperation system (not shown) to be used for a social security number, a credit card number, or the like according to the purpose of use. In particular, when the actual secret information interpreted by the authentication server 10 is a password, a determination is made as to whether the password matches with the user secret information stored in the database to determine whether to authenticate the information.

In the method for authenticating one-time virtual secret information according to the fifth embodiment of the present invention, when the “n” one-time virtual secret information are all input to the PC 40b, the PC requests the display device 30b to encrypt the matching information, and the display device 30b encrypts the matching information with the encryption key value stored in the memory, so that the “n” one-time virtual secret information and the encrypted matching information are transmitted to the authentication server.

As another alternative to the method for authenticating one-time virtual secret information according to the fifth embodiment of the present invention, when the “n” one-time virtual secret information are all input to the PC 40b, the PC transmits the “n” one-time virtual secret information to the display device and requests the display device 30b to encrypts the one-time virtual secret information, and the display device 30b interprets actual secret information from one-time virtual secret information using the matching information. The display device 30b encrypts the interpreted actual secret information with the encryption key value stored in the memory, and transmits the encrypted actual secret information to the authentication server 10 via the PC 40b.

The inputting and outputting of the “n” one-time virtual secret information and matching information according to the third to fifth embodiments of the present invention are the same as those according to the first embodiment of the present invention.

The method for authenticating one-time virtual secret information according to the third to fifth embodiments of the present invention may further include: when the “n” one-time virtual secret information are input to the authentication server 10, transmitting, by the authentication, the “n” one-time virtual secret information to the display device 30b to confirm whether the user has correctly inputted the “n” one-time virtual secret information.

As described above, in the method for authenticating one-time virtual secret information according to the third to fifth embodiments of the present invention, the display of the matching information is made by the portable display device being free from hacking. Accordingly, a hacker who attempts to hack the PC via the Internet may obtain one-time virtual secret information, but cannot obtain user's true secret information, thereby incapacitating hacking.

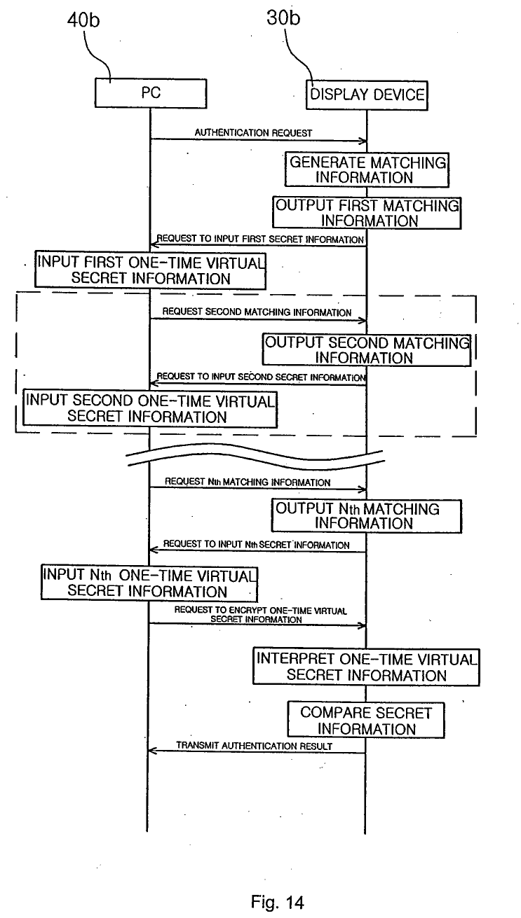

Referring to FIG. 14, a method for authenticating one-time virtual secret information according to a sixth embodiment of the present invention is intended to determine whether to approve use of a USB when a PC interface of a display device is the USB.

In response to a request from the PC 40b, the display device 30b generates and displays first matching information.

A user then inputs one-time virtual secret information matching with an index value corresponding to the first secret information in the matching information displayed on the display device, to the PC.

When the one-time virtual secret information is input to the PC, the display device generates and outputs second matching information.

In this method, the authentication server repeatedly generates and outputs matching information to the display device until “n” one-time virtual secret information are input to the PC.

When the “n” one-time virtual secret information are all input to the PC 40b, the PC transmits the “n” one-time virtual secret information to the display device.

The display device 30b then interprets the “n” input one-time virtual secret information based on the matching information and determines whether to approve use of the display device 30b.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A system for authenticating one-time virtual secret information, the system comprising:
a display device having a central processing unit (CPU) and a memory;
an input device having a CPU and a memory, wherein the input device is separated from the display device to allow the display device and the input device to independently process information; and
an authentication server for generating matching information, the authentication server including a database, wherewith the authentication server provides the generated matching information to the display device via a first communication network, and the display device displays the matching information for a user to view and use the matching information for inputting the one-time virtual secret information to the input device for transmittal of the input one-time virtual secret information to the authentication server via a second communication network, where the authentication server interprets the input one-time virtual secret information to determine whether to authenticate the input information.

2. The system of claim 1, wherein the matching information includes a secret information index table including ten sequential numeric digits, and a secret information matching value table including ten numeric digits randomly matching with the numeric digits of the secret information index table, respectively.

3. The system of claim 2, wherein the secret information index table of the matching information is capable of including any one of a combination of alphabetic letters, alphabetic letters and numeric digits, a combination of the numeric digits and special characters, a combination of the alphabetic letters and the special characters, and a combination of the numeric digits, the alphabetic letters, and the special characters, and the combination of alphabetic letters, alphabetic letters and numeric digits, the combination of the numeric digits and special characters, the combination of the alphabetic letters and the special characters, or the combination of the numeric digits, the alphabetic letters, and the special characters is capable of being randomly written to the secret information matching value table 65 in a one-to-one correspondence relationship.

4. The system of claim 1, wherein the first and second communication networks are selected from a group consisting of the Internet, a mobile communication network, and a public switched telephone network, and the communication network connecting between the authentication server and the display device and the communication network connecting between the authentication server and the input device differ from each other.

5. The system of claim 1, wherein the display device is either a mobile phone or a display device, the display device comprising a CPU, a memory having an authenticated key for a user stored therein, a display unit for displaying matching information, a personal computer (PC) interface for connection to a PC, and a controller for controlling the PC interface and the display unit.

6. The system of claim 5, wherein the PC interface is selected from a group consisting of a universal serial bus (USB), a serial/parallel port, Bluetooth, a 1394 port, and Radio-frequency identification (RFID).

7. A method for authenticating one-time virtual secret information, the method comprising:
connecting a first device to an authentication server via a first communication network, and connecting a second device to the authentication server via a second communication network;
generating, by the authentication server, first matching information and outputting the first matching information to the second device via the second communication network for display on the second device;
inputting to the first device, by a user, one-time virtual secret information matching with an index value corresponding to the first secret information in the matching information displayed on the second device;
generating, by the authentication server, second matching information and outputting the second matching information to the second device when the one-time virtual secret information is input to the first device;
repeatedly generating and outputting, by the authentication server, matching information to the second device until “n” one-time virtual secret information are input to the first device;
transmitting, by the first device, the “n” one-time virtual secret information to the authentication server when the “n” one-time virtual secret information are all input to the first device; and
interpreting, by the authentication server, the input one-time virtual secret information, based on its generated matching information.

8. A method of claim 7 wherein the first device is a mobile phone and the second device is a personal computer.

9. The method of claim 8, wherein the authentication server is capable of generating “n” matching information, tying the “n” matching information into one information package, and transmitting the information package to the mobile phone, and when the authentication server sends a signal to the mobile phone to request the mobile phone to output next matching information, the mobile phone is capable of sequentially displaying the matching information in the information package in response to the request.

10. The method of claim 8, further comprising: when the “n” one-time virtual secret information are input to the authentication server, transmitting, by the authentication server, the “n” one-time virtual secret information to either the mobile phone or the PC to confirm whether the user has correctly inputted the “n” one-time virtual secret information.

11. A method of claim 7 wherein the first device is a personal computer and the second device is a mobile phone.

12. The method of claim 11, wherein the authentication server is capable of generating “n” matching information, tying the “n” matching information into one information package, and transmitting the information package to the mobile phone, and when the authentication server sends a signal to the mobile phone to request the mobile phone to output next matching information, the mobile phone is capable of sequentially displaying the matching information in the information package in response to the request.

13. The method of claim 11, further comprising: when the “n” one-time virtual secret information are input to the authentication server, transmitting, by the authentication server, the “n” one-time virtual secret information to either the mobile phone or the PC to confirm whether the user has correctly inputted the “n” one-time virtual secret information.

14. A method for authenticating one-time virtual secret information, the method comprising:
generating, by a display device, first matching information in response to a request from a PC and displaying the first matching information;
inputting, by a user, one-time virtual secret information matching with an index value corresponding to its first secret information in the matching information displayed on the display device, to the PC;
generating, by the display device, second matching information and outputting the second matching information when the one-time virtual secret information is input to the PC;
repeatedly generating and outputting, by an authentication server, matching information to the display device until “n” one-time virtual secret information are input to the PC;
transmitting, by the PC, the “n” one-time virtual secret information to the display device and requesting to encrypt the “n” one-time virtual secret information and the matching information when the “n” one-time virtual secret information are all input to the PC;
encrypting, by the display device, the “n” one-time virtual secret information with an encryption key value stored in a memory, and transmitting the encrypted secret information to the authentication server via the PC; and
decrypting, by the authentication server, the encrypted one-time virtual secret information and matching information and interpreting the one-time virtual secret information and the matching information.

15. The method of claim 14, wherein when the “n” one-time virtual secret information are all input to the PC, the PC requests to encrypt the matching information and the display device encrypts the matching information with the encryption key value stored in the memory, so that the “n” one-time virtual secret information and the encrypted matching information are transmitted to the authentication server.

16. The method of claim 14, wherein when the “n” one-time virtual secret information are all input to the PC, the PC transmits the “n” one-time virtual secret information to the display device and requests to encrypts the one-time virtual secret information, and the display device interprets actual secret information from the one-time virtual secret information using the matching information, encrypts the interpreted actual secret information with the encryption key value stored in the memory, and transmits the encrypted actual secret information to the authentication server via the PC.

17. The method of claim 14, further comprising the step of: transmitting, by the authentication server, the “n” one-time virtual secret information to the display device to confirm whether the user has correctly inputted the “n” one-time virtual secret information when the “n” one-time virtual secret information are input to the authentication server.

18. The method of claim 14, wherein the authentication server is capable of generating the “n” matching information, tying the “n” matching information into one information package, and transmitting the information package to the display device, and when the authentication server sends a signal to the display device to request the display device to output next matching information, the display device is capable of sequentially displaying the matching information in the information package in response to the request.

19. A method for authenticating one-time virtual secret information, the method comprising:
generating, by a display device, first matching information in response to a request from a PC and displaying the first matching information;
inputting, by a user, one-time virtual secret information matching with an index value corresponding to its first secret information in the matching information displayed on the display device, to the PC;
generating and outputting, by the display device, second matching information, when the one-time virtual secret information is input to the PC;
repeatedly generating and outputting, by an authentication server, matching information to the display device until “n” one-time virtual secret information are input to the PC in that way;
transmitting, by the PC, the “n” one-time virtual secret information to the display device, when the “n” one-time virtual secret information are all input to the PC; and
interpreting, by the display device, the “n” input one-time virtual secret information, based on the matching information, and determining whether to approve use of the display device.
